(19) United States
(12) Patent Application Publication
(10) Pub. No.: US 2020/0303732 A1
(43) Pub. Date: Sep. 24, 2020

(54) METHOD FOR PRODUCING BATTERY PACK AND METHOD FOR MANUFACTURING ELECTRICITY STORAGE DEVICE

(71) Applicant: KANEKA CORPORATION, Osaka-shi (JP)

(72) Inventor: Akiko WAKI, Settsu-shi (JP)

(73) Assignee: KANEKA CORPORATION, Osaka-shi (JP)

(21) Appl. No.: 16/088,753

(22) PCT Filed: Mar. 29, 2017
(86) PCT No.: PCT/JP2017/012879

§ 371 Date: Sep. 26, 2018

(30) Foreign Application Priority Data
Mar. 31, 2016 (JP) 2016-071725

(51) Int. Cl. H01M 4/485; H01M 10/0525; H01M 2/10; H01M 4/48; H01M 4/505; H01M 4/525; H02J 7/02; H02J 7/00; H01M 10/0566; H01M 10/44

(52) U.S. Cl. CPC H01M 4/485; H01M 10/0525; H01M 2/1077; H01M 4/483; H01M 10/441; H01M 4/525; H02J 7/02; H02J 7/0013; H01M 10/0566; H01M 4/505

(57) ABSTRACT

A method for producing a battery pack includes: charging each of a plurality of batteries to 100% state of charge (SOC); and connecting the charged batteries to form the battery pack. At least some of the batteries in the battery pack are serially connected to each other, and each of the plurality of batteries has a positive electrode including a layered rock salt type compound and a negative electrode including a titanium compound. A method for manufacturing an electricity storage device includes, after the battery pack is produced, discharging the battery pack to 30% SOC or more by using a charging and discharging device.

### TECHNICAL FIELD

The present invention relates to a method for producing a battery pack and relates to a method for manufacturing an electricity storage device formed by the battery pack.

### TECHNICAL BACKGROUND

In recent years, lithium ion secondary batteries that are used in mobile devices, hybrid vehicles, electric vehicles, household electricity storage applications or the like are required to have not only a high energy density but also multiple characteristics such as high safety, a long service life and a low cost in a well-balanced manner.

Such lithium ion secondary batteries are used by combining multiple batteries in serial connection or parallel connection, or in direct connection and parallel connection to form a battery pack. Since most of batteries have capacity differences, when a battery pack having a structure formed by connecting batteries in series is charged, a battery having a smaller capacity reaches a fully charged state earlier, and further becomes overcharged, which is a problem of a battery pack. Then, when overcharging is repeated, a capacity retention rate of the battery decreases rapidly.

For example, Patent Document 1 discloses an electricity storage device in which unit batteries are first fully charged, and thereafter, the unit batteries are discharged by the same capacity, and then, these unit batteries are connected in series to form a battery pack. With such a technique, overcharging of a battery in an electricity storage device is suppressed.

### RELATED ART

Patent Document

[Patent Document 1] Japanese Patent Laid-Open Publication No. HEI 10-149807.

### SUMMARY OF THE INVENTION

### Problems to be Solved by the Invention

However, the present inventor has found that, in Patent Document 1, there is a problem that it is necessary to discharge the unit batteries by the same capacity before forming the battery pack, otherwise firing occurs in the battery pack.

The present invention is accomplished in order to solve the above problem. An objective of the present invention is to provide a battery pack and an electricity storage device that allow a sufficient state of charge to be maintained while allowing a decrease in capacity retention rate, firing, and the like due to overcharging to be suppressed.

### Means for Solving the Problems

A method for producing a battery pack according to the present invention is a method for producing a battery pack that includes multiple batteries, at least some of the batteries being directly connected to each other. The multiple batteries each include a positive electrode that contains a layered rock salt type compound and a negative electrode that contains a titanium compound. A process in which the multiple batteries are charged to a state of charge (SOC) of 100% and a process in which the multiple batteries are connected to form the battery pack are sequentially performed.

### Effect of Invention

According to the present invention, in the battery pack and the electricity storage device, a sufficient state of charge is maintained while overcharging, firing, and the like are suppressed.

### BRIEF DESCRIPTION OF DRAWINGS

FIG. 1 is a perspective view of an electricity storage device according to the present invention.

FIGS. 2(a)-2(d) are schematic diagrams illustrating a method for producing a battery pack according to the present invention and illustrating a flow when the produced battery pack is discharged.

FIGS. 3(a)-3(d) are schematic diagrams illustrating a method for producing a conventional battery pack and illustrating a flow when the produced battery pack is discharged.

### MODE FOR CARRYING OUT THE INVENTION

### <Electricity Storage Device>

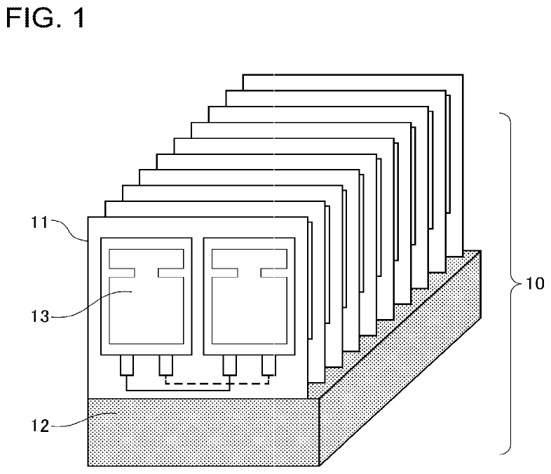

The present invention is described with reference to FIG. 1 which is an embodiment of an electricity storage device. FIG. 1 is a perspective view of the electricity storage device. The electricity storage device 10 includes a battery pack 11 and a charging and discharging device 12, the battery pack 11 including multiple batteries 13.

### <Batteries>

The batteries 13 are each formed by sealing a laminated body, a nonaqueous electrolyte solution and terminals with an inclusion body, the laminated body including a positive electrode, a negative electrode and a separator.

### <Positive Electrode and Negative Electrode>

The positive electrode and the negative electrode have a function of performing insertion and extraction of metal ions. Due to the insertion and the extraction, charging and discharging of a battery is performed.

The positive electrode includes an active material layer, which includes a positive electrode active material that contributes to the insertion and the extraction of metal ions, and a current collector.

The positive electrode active material is required to contain a layered rock salt type compound.

The layered rock salt type compound is an active material having a layered rock salt type crystal structure, and has an effect of suppressing gas generation. As a result of intensive studies, the inventor has found that the gas suppression effect of the layered rock salt type compound tends to be higher when the SOC is higher.

The layered rock salt type compound is not particularly limited as long as the compound has a layered rock salt type crystal structure. From a point of view of having a large gas suppression effect, lithium cobalt oxide (LiCoO₂), nickel cobalt lithium aluminate (LiNi_{0.8}Co_{0.15}Al_{0.05}O₂), or lithium nickel cobalt manganese oxide (LiNiₓCo_{y}Mn_{1-y-z}O₂, x+y+z=1) are preferable, and LiCoO₂ is more preferable.

From a point of view of having a good balance between the gas generation suppression effect and material deterioration of the layered rock salt type active material, a number average particle diameter of the layered rock salt type active material based on appearance is preferably 3 μm or more and 9 μm or less, and more preferably 5 μm or more and 7 μm or less.

The “number average particle diameter” is obtained by observing 100 arbitrarily-selected particles by electron microscopic observation such as using an SEM and adopting an average particle diameter of the 100 particles.

From a point of view of having a good balance between the gas generation suppression effect and material deterioration of the layered rock salt type active material, a specific surface area of the layered rock salt type active material is preferably 0.3 m²/g or more and 0.6 m²/g or less, and more preferably 0.4 m²/g or more and 0.5 m²/g or less.

Further, the positive electrode active material preferably contains a metal oxide or a metal transition metal composite oxide, and more preferably contains a lithium transition metal composite oxide.

As the lithium transition metal composite oxide, from a point of view of exhibiting good cycle characteristics, Li₂MnO₃ or spinel type lithium manganate represented by Formula 1 is preferable:

[Chemical Formula 1]

Li₁₊ₓM_{y}Mn_{2-x-y}O₄ (1)

(where 0≤x≤0.2; 0<y≤0.6; and M is at least one element selected from a group consisting of elements belonging to Groups 2-13 and Periods 3 and 4).

For the spinel type lithium manganate, from a point of view of good battery stability, M is preferably at least one element selected from a group consisting of Al, Mg, Zn, Ni, Co, Fe, Ti, Cu, Zr and Cr; and, from a point of view that the positive electrode active material itself has particularly good stability, M is more preferably at least one element selected from a group consisting of Al, Mg, Zn, Ti and Ni.

Specifically,

Li₁₊ₓAl_{y}Mn_{2-x-y}O₄ (0≤x≤0.1, 0<y≤0.1),
Li₁₊ₓMg_{y}Mn_{2-x-y}O₄ (0≤x≤0.1, 0<y≤0.1),
Li₁₊ₓZn_{y}Mn_{2-x-y}O₄ (0≤x≤0.1, 0<y≤0.1),
Li₁₊ₓCr_{y}Mn_{2-x-y}O₄ (0≤x≤0.1, 0<y≤0.1),
Li₁₊ₓNi_{y}Mn_{2-x-y}O₄ (0≤x≤0.05, 0.45≤y≤0.5),
Li₁₊ₓNi_{y-z}Al_{z}Mn_{2-x-y}O₄ (0≤x≤0.05, 0.45≤y≤0.5, 0.005≤z≤0.03),
or Li₁₊ₓNi_{y-z}Ti_{z}Mn_{2-x-y}O₄ (0≤x≤0.05, 0.45≤y≤0.5, 0.005≤z≤0.03) is preferable,
Li₁₊ₓAl_{y}Mn_{2-x-y}O₄ (0≤x≤0.1, 0<y≤0.1),
Li₁₊ₓMg_{y}Mn_{2-x-y}O₄ (0≤x≤0.1, 0≤y≤0.1),
Li₁₊ₓNi_{y}Mn_{2-x-y}O₄ (0≤x≤0.05, 0.45≤y≤0.5),
or Li₁₊ₓNi_{y-z}Ti_{z}Mn_{2-x-y}O₄ (0≤x≤0.05, 0.45≤y≤0.5, 0.005≤z≤0.03) is more preferable, and
Li₁₊ₓ Ni_{y}Mn_{2-x-y}O₄ (0≤x≤0.05, 0.45≤y≤0.5),
or Li₁₊ₓNi_{y-z}Ti_{z}Mn_{2-x-y}O₄ (0≤x≤0.05, 0.45≤y≤0.5, 0.005≤z≤0.03) is even more preferable.

These positive electrode active materials may each be independently used, or two or more of these positive electrode active materials may be used in combination.

For a purpose of obtaining suitable conductivity and stability, a surface of the positive electrode active material may be covered with a carbon material, a metal oxide, or a polymer, or the like.

The negative electrode includes a negative electrode active material that contributes to the insertion and the extraction of metal ions.

The negative electrode active material is required to contain a titanium compound, and preferably contains 50 wt % or more, and more preferably contains 80 wt % or more of a titanium compound as a component.

The batteries 13 for which the negative electrode active material is a titanium compound are thermally stable even when the SOC of the batteries is 100%, and thus, a risk of firing due to abnormality such as an external short circuit is suppressed.

The titanium compound has a characteristic that the compound hardly deteriorates even when a battery is charged and discharged from an SOC of 100% to an SOC of 0%. The reason is that, in theory, open circuit voltages (OCV) of battery cells are all equal to each other, an OCV difference becomes 0 even when an SOC of the electricity storage device 10 is 100%, and the electricity storage device 10 does not become overcharged.

Here, the term “open circuit voltage (OCV)” is a voltage between battery terminals in a state in which no external load is applied to the batteries 13 and in a state in which no current flows in the batteries 13.

As the titanium compound, at least one selected from a group consisting of a titanic acid compound, a lithium titanate or a titanium dioxide is preferable, and a lithium titanate is more preferable.

The titanic acid compound is preferably H₂Ti₃O₇, H₂Ti₄O₉, H₂Ti₅O₁₁, or H₂Ti₆O₁₃, H₂Ti₁₂O₂₅, and is more preferably H₂Ti₁₂O₂₅ from a point of view of having stable cycle characteristics.

The lithium titanate preferably has a spinel structure and is of a ramsdellite type, and more preferably has a spinel structure represented by Li₄Ti₅O₁₂ as a molecular formula. In the case of the spinel structure, expansion and contraction of an active material in an insertion and extraction reaction of lithium ions are small.

Examples of the titanium dioxide include a bronze (B) type titanium dioxide, an anatase type titanium dioxide, at ramsdellite type titanium dioxide, and the like. From a point of view of having a small irreversible capacity and excellent cycle stability, the B type titanium dioxide is preferable.

Particularly preferably, the titanium compound is Li₄Ti₅O₁₂.

Further, the negative electrode active material preferably contains a metal oxide and/or a lithium metal oxide, and more preferably contains 50 wt % or less of a metal oxide and/or a lithium metal oxide as a component.

For a purpose of obtaining suitable conductivity and stability, a surface of the negative electrode active material may be covered with a carbon material, a metal oxide, or a polymer, or the like.

When the positive electrode active material layer and the negative electrode active material layer each have a thickness of 10 μm or more and 200 μm or less, the positive electrode active material layer and the negative electrode active material layer can be suitably used.

The positive electrode and the negative electrode may each further contain a conductive additive.

The conductive additive is a conductive or semiconductive substance added for a purpose of assisting conductivity of the electrodes.

As the conductive additive, a metal material or a carbon material is suitably used.

As the metallic material, copper or nickel or the like is suitably used. Further, examples of the carbon material include natural graphite, artificial graphite, vapor grown carbon fiber, carbon nanotube, and carbon black such as acetylene black, ketchen black, and furnace black.

These conductive additives may each be independently used, or two or more of these conductive additives may be used.

An amount of the conductive additive contained in the positive electrode with respect to 100 parts by weight of the positive electrode active material is preferably 1 part by weight or more and 30 parts by weight or less, and more preferably 2 parts by weight or more and 15 parts by weight or less. When the amount of the conductive additive is within this range, the conductivity of the positive electrode is ensured. Further, adhesiveness to a binder to be described later can be maintained, and sufficient adhesiveness to the current collector can be obtained.

An amount of the conductive additive contained in the negative electrode with respect to 100 parts by weight of the negative electrode active material is preferably 1 part by weight or more and 30 parts by weight or less, and more preferably 2 parts by weight or more and 15 parts by weight or less. When the amount of the conductive additive is within this range, the conductivity of the negative electrode is ensured.

The positive electrode and the negative electrode may each further contain a binder.

The binder is a material that enhances a binding property between the active material and the current collector.

The binder is not particularly limited. However, when the binder is at least one selected from a group consisting of polyvinylidene fluoride (PVdF), polytetrafluoroethylene (PTFE), styrene-butadiene rubber, polyimide, and derivatives thereof, the binder can be suitably used.

An amount of the binder with respect to 100 parts by weight of the active material of the positive electrode or the negative electrode is preferably 1 part by weight or more and 30 parts by weight or less, and more preferably 2 parts by weight or more and 15 parts by weight or less. When the amount of the binder is within this range, adhesiveness between the positive electrode or negative electrode active material and the conductive additive is maintained, and sufficient adhesiveness to the current collector is obtained.

The current collector is a member that collects current from the active material layer.

In the positive electrode and the negative electrode, the active material may be formed on one side or both sides of the current collector.

Further, it is also possible to have a form, that is, a form of a bipolar type, in which the positive electrode active material layer is formed on one side of a current collector, and the negative electrode active material layer is formed on the other side of the current collector.

The current collector is preferably aluminum or an alloy of aluminum, and, from a point of view of being stable under a positive electrode reaction atmosphere, is more preferably high purity aluminum typified by JIS standards 1030, 1050, 1085, 1N90, 1N99, or the like.

A thickness of the current collector is not particularly limited, but is preferably 10 μm or more and 100 μm or less.

### <Method for Producing Positive Electrode and Negative Electrode>

As a method for producing the positive electrode and the negative electrode, a method is suitably used in which at least a slurry containing at least an active material and a solvent is prepared, and thereafter, the slurry is carried on a current collector, and then, the solvent is removed to form an active material layer on the current collector.

The slurry can be prepared using a conventional commonly known technique. Further, also for the solvent of the slurry, the carrying, and the removal of the solvent, conventional commonly known techniques can be used.

### <Laminated Body>

In the laminated body, the positive electrode, the negative electrode and the separator are alternately laminated or wound.

The number of laminated layers or the number of windings of the laminated body 5 may be appropriately adjusted according to a desired voltage value and a desired battery capacity.

### <Separator>

The separator is arranged between the positive electrode and the negative electrode and functions as a medium that mediates conduction of lithium ions between the positive electrode and the negative electrode while preventing conduction of electrons and holes between the positive electrode and the negative electrode, and at least does not have electron and hole conductivity.

As the separator, any electrically insulating material can be suitably used. Specifically, nylon, cellulose, polysulfone, polyethylene, polypropylene, polybutene, polyacrylonitrile, polyimide, polyamide, polyethylene terephthalate, and combinations of two or more thereof can be used.

As a shape of the separator, a woven fabric, a nonwoven fabric or a microporous membrane, or the like is suitably used as long as the material can form a structure that can be arranged between the positive electrode and the negative electrode and is insulating and can contain a nonaqueous electrolyte solution.

The separator may contain a plasticizer, an antioxidant or a flame retardant, and may be coated with a metal oxide or the like.

A thickness of the separator is preferably 10 μm or more and 100 μm or less, and more preferably 15 μm or more and 50 μm or less.

A porosity of the separator is preferably 30% or more and 90% or less, and, from a point of view of having a good balance between lithium ion diffusivity and a short circuit prevention property, is more preferably 35% or more and 85% or less, and, from a point of view that the balance is particularly excellent, is even more preferably 40% or more and 80% or less.

### <Nonaqueous Electrolyte Solution>

The nonaqueous electrolyte solution has a function of mediating ion transfer between the negative electrode and the positive electrode.

The nonaqueous electrolyte solution may be an electrolyte solution obtained by dissolving a solute in a solvent, or may be a gel electrolyte obtained by impregnating a polymer with an electrolyte solution obtained by dissolving a solute in a nonaqueous solvent.

As the solute of the nonaqueous electrolyte solution, a solute can be suitably used as long as the solute is a lithium salt containing lithium and halogen.

As the lithium salt, LiPF₆, LiClO₄, LiBF₄, LiAsF₆, LiCF₃SO₃, LiBOB (Lithium Bis (Oxalato) Borate), Li[N(SO₂CF₃)₂], Li[N(SO₂C₂F₅)₂], Li[N(SO₂F)₂], or Li[N(CN)₂] is preferable, and LiPF₆ is more preferable.

The lithium salt is suitably used as long as a concentration of the lithium salt in the nonaqueous electrolyte solution is 0.5 mol/L or more and 1.5 mol/L or less.

As the solvent of the nonaqueous electrolyte solution, from a point of view that solvent decomposition is unlikely to occur at an operating potential of a battery and from a point of view that the lithium salt has a good solubility, an aprotic polar solvent is more preferable.

Examples of the aprotic polar solvent include carbonate, ester, ether, phosphate ester, amide, sulfuric acid ester, sulfite ester, sulfone, sulfonic acid ester, nitrile and the like.

Among these aprotic polar solvents, a cyclic aprotic solvent and/or a chain aprotic solvent is more preferable, and, from a point of view that the conductivity of the lithium ions is good, a mixed solvent of a cyclic aprotic polar solvent and a chain aprotic polar solvent is most preferable.

Examples of the cyclic aprotic polar solvent include cyclic carbonate, cyclic ester, cyclic sulfone and cyclic ether.

Examples of the cyclic carbonate include ethylene carbonate (EC), propylene carbonate (PC), fluoroethylene carbonate, butylene carbonate and the like.

Examples of the chain aprotic polar solvent include acetonitrile, chain carbonate, chain carboxylic acid ester, chain ether, and the like.

Examples of the chain carbonate include dimethyl carbonate, diethyl carbonate, ethyl methyl carbonate (EMC), dipropyl carbonate, methyl propyl carbonate, and the like.

From a point of view of having a good balance between viscosity and solubility, a ratio of the chain aprotic polar solvent in the mixed solvent is preferably 5 vol %-95 vol %, more preferably 10 vol %-90 vol %, even more preferably 20 vol %-80 vol %, and particularly preferably 50 vol %-80 vol %.

Further, in addition to the nonaqueous solvent, a solvent that is commonly used as a solvent of a nonaqueous electrolyte solution such as acetonitrile may also be used.

The nonaqueous electrolyte solution may further contain an additive such as a flame retardant.

### <Terminals>

The terminals have a function of electrically connecting the batteries 13 and an external device.

The terminals are connected to the laminated body, and terminal extension parts which are respectively portions of the terminals extend to the outside of the inclusion body.

From a point of view that self-discharge of the batteries 13 is suppressed, the terminal extending portions are preferably covered with an insulator.

As the terminals, any material can be suitably used as long as the material is a conductor, and, from a point of view of having a good balance between performance and cost, aluminum is more preferable.

### <Inclusion Body>

The inclusion body is a member enclosing the laminated body, the nonaqueous electrolyte solution, and the terminals electrically connecting to the laminated body, and has a function of protecting the enclosed members from moisture, air or the like.

As the inclusion body, a composite film obtained by providing a thermoplastic resin layer for heat sealing on a metal foil, a metal layer formed by vapor deposition or sputtering, or a metal can of a square shape, an oval shape, a cylindrical shape, a coin shape, a button shape or a sheet shape, is suitably used, and the composite film is more preferable.

As the metal foil of the composite film, from a point of view of having a good balance between a moisture blocking property, a weight and a cost, an aluminum foil is suitably used.

As the thermoplastic resin layer of the composite film, from a point of view that a heat-sealing temperature range and a blocking property of the nonaqueous electrolyte solution are good, polyethylene or polypropylene is suitably used.

### <Battery Pack and Method for Producing Battery Pack>

In the battery pack 11, at least some of the multiple batteries 13 are required to be connected in series, and, preferably, the batteries 13 are connected in combination of a parallel connection and a serial connection.

In the following, a method for producing the battery pack 11 is described. In the method for producing the battery pack 11, a process in which the multiple batteries 13 are charged to an SOC of 100%, and a process in which the charged multiple batteries 13 are connected to form the battery pack 11 are sequentially performed.

Here, the term “100% SOC” refers to a state in which a battery is charged or discharged to a charge or discharge termination voltage specified by a battery manufacturer. The charging and discharging of a battery is managed with a voltage value, and a battery manufacturer specifies a a charge termination voltage and a discharge termination voltage. A state of discharging to the discharge termination voltage is 10% SOC, and a state of charging to the charge termination voltage is 100% SOC.

In general, batteries should have the same battery capacity (hereinafter referred to as the “design capacity”) in terms of design. However, due to production variations (for example, variations in electrode thickness and the like), even when the batteries are charged to the charge termination voltage (100% SOC), actually obtained charge capacities (hereinafter referred to as the “actual capacities”) are not necessarily the same as each other. Therefore, when multiple batteries are connected in series and are charged to the charge termination voltage (100% SOC), a battery having a small actual capacity is overcharged.

Therefore, by having a process in which, prior to connecting in series the multiple batteries 13 which form the battery pack, the batteries 13 are each charged up to 100% SOC, even when there is variation in the actual capacities of the batteries 13, the batteries 13 are each charged to 100% SOC, and thus, it is possible to prevent any one of the batteries from being overcharged. As a result, it is possible to prevent a state in which overcharging or undercharging remains among the batteries as in the case where the multiple batteries are charged as a battery pack. As a result, it is possible to improve the cycle life of the battery pack, and it is possible to suppress a decrease in a capacity retention rate.

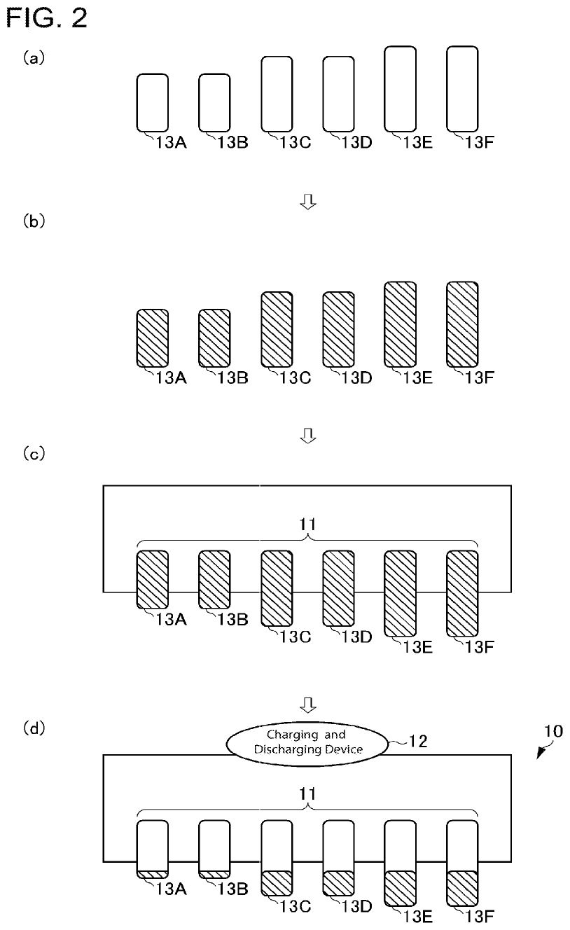

More specifically, performance of the battery pack 11 is described with reference to FIG. 2. FIG. 2 schematically illustrates a method for producing the battery pack 11 and illustrates a flow until the produced battery pack 11 is discharged by the charging and discharging device. FIG. 2(a) is a schematic diagram illustrating a state of the multiple batteries 13 (13A-13F) before charging; FIG. 2(b) is a schematic diagram illustrating a state when the multiple batteries 13 are each charged; and FIG. 2(c) is a schematic diagram illustrating a state when the charged batteries 13 are connected to form the battery pack 11. Then, FIG. 2(d) is a schematic diagram illustrating a state after the battery pack 11 is connected to the charging and discharging device 12 and is discharged as the electricity storage device 10.

For example, the actual capacities of the batteries (13A-13F) that form the battery pack 11 are as follows: the battery (13A): 10.0 Ah; the battery (13B): 10.0 Ah; the battery (13C): 10.4 Ah; the battery (13D): 10.4 Ah; the battery (13E): 10.8 Ah; and the battery (13A): 10.8 Ah.

Sizes of the batteries (13A-13F) that are respectively schematically illustrated in rectangular shapes in FIG. 2 respectively correspond to the actual capacities of the batteries (13A-13F). Further, the term “charge capacity” to be described later refers to a charged capacity, and a size of an area indicated with oblique lines in FIG. 2 corresponds to a charge capacity.

First, as illustrated in FIG. 2(a), for example, to form the battery pack 11, the multiple batteries (13A-13F) are used. These multiple batteries (13A-13F) have mutually different actual capacities. That is, there is a difference in actual capacity between the batteries (13A-13F).

Next, as illustrated in FIG. 2(b), prior to connecting the multiple batteries (13A-13F) to form the battery pack, the batteries (13A-13F) are each charged to 100% SOC. Since the multiple batteries (13A-13F) that have not yet been connected are each independently charged, the charge capacities of the batteries (13A-13F) are respectively the same as their actual capacities, that is, the charge capacities are as follows: the battery (13A): 10.0 Ah; the battery (13B): 10.0 Ah; the battery (13C): 10.4 Ah; the battery (13D): 10.4 Ah; the battery (13E): 10.8 Ah; and the battery (13F): 10.8 Ah. In this way, since the multiple batteries (13A-13F) are each charged prior to connecting the batteries (13A-13F) to form the battery pack, even when there is variation in the actual capacities of the batteries (13A-13F), each of the batteries (13A-13F) is charged to 100% SOC corresponding to the actual capacity of the battery, and it is possible to prevent any one of the batteries (13A-13F) from being overcharged.

Next, as illustrated in FIG. 2(c), the battery pack 11 is formed by connecting the batteries (13A-13F), which have each been charged to 100% SOC, such that at least some of the batteries (13A-13F) are connected in series. In this way, the battery pack 11 is produced by connecting the batteries (13A-13F) in the state in which the batteries (13A-13F) have each been charged to 100% SOC

When the charging and discharging device 12 is connected to the battery pack 11, which is structured as described above, to form the electricity storage device 10 and, for example, the battery pack 11 is discharged to 30% SOC, as illustrated in FIG. 2(d), the charge capacities of the batteries (13A-13F) are as follows: the battery (13A): 2.7 Ah; the battery (13B): 2.7 Ah; the battery (13C): 3.1 Ah; the battery (13D): 3.1 Ah; the battery (13E): 3.5 Ah; and the battery (13F): 3.6 Ah. Then, in this case, values of “actual capacity-designed charge capacity” of the batteries (13A-13F) are approximately equal to each other.

That is, in this way, the state in which the values of “actual capacity-designed charge capacity” of the batteries (13A-13F) are approximately equal to each other can be maintained, and thereby, even when the battery pack 11 is charged again to 100% SOC 100%, chargeable electric capacities of the batteries (13A-13F) to the 100% SOC are approximately equal to each other, and overcharging does not occur in any one of the batteries (13A-13F). Therefore, according to the battery pack 11 produced as described above, even when charging and discharging are repeated, overcharging is suppressed, and a decrease in a capacity retention rate can be suppressed.

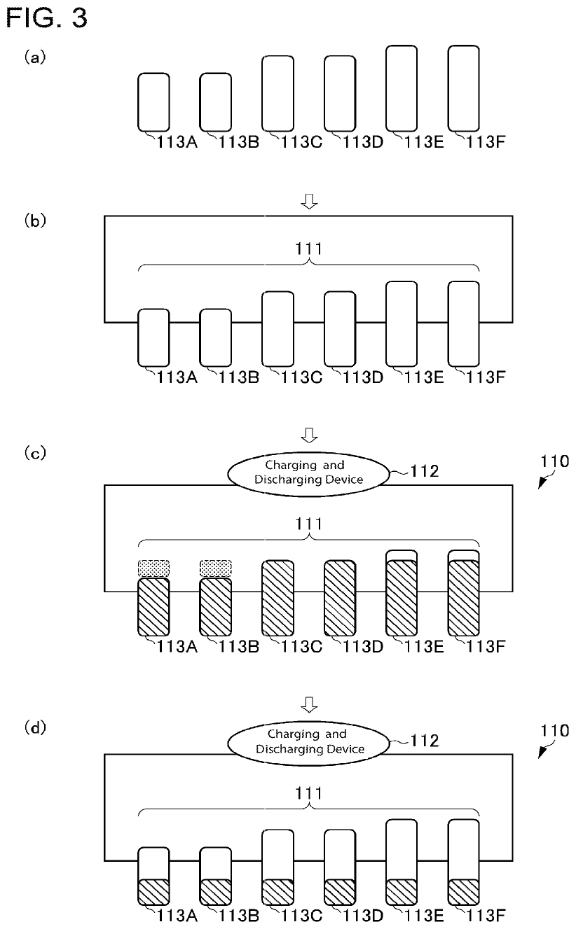

Next, for comparison, with reference to FIG. 3 (an example of a conventional production method), a case is described in which multiple batteries having different actual capacities are connected to form a battery pack and thereafter the battery pack is charged. FIG. 3(a) is a schematic diagram illustrating a state of the multiple batteries before charging; FIG. 3(b) is a schematic diagram illustrating a state when the multiple batteries are connected to form the battery pack; FIG. 3(c) is a schematic diagram illustrating a state when the battery pack is charged after the battery pack is formed; and FIG. 3(d) is a schematic diagram illustrating a state after the battery pack is discharged.

Similar to the batteries (13A-13F) illustrated in FIG. 2, the actual capacities of the multiple batteries (113A-113F) forming the battery pack 111 are as follows: the battery (113A): 10.0 Ah; the battery (113B): 10.0 Ah; the battery (113C): 10.4 Ah; the battery (113D): 10.4 Ah; the battery (113E): 10.8 Ah; and the battery (113A): 10.8 Ah.

First, as illustrated in FIG. 3(a) and FIG. 3(b), the battery pack 111 is formed by connecting the batteries (113A-113F) for which there is variation in the actual capacities thereof. As illustrated FIG. 3(b), the battery pack 111 is formed by connecting the multiple batteries (113A-113F) which are in a state of before being charged.

Next, after the battery pack 111 is formed by connecting the multiple batteries (113A-113F), as illustrated in FIG. 3(c), a charging and discharging device 112 is connected to the battery pack 111 to formed an electricity storage device 110, and, due to the charging and discharging device 112, the battery pack is charged with a constant current value until a voltage of 6 times a charge termination voltage is reached. Here, that a voltage of 6 times the charge termination voltage is a termination point is because 6 batteries (113A-113F) are connected in series in the battery pack. When a design capacity at the time of battery design is 10.4 Ah, the batteries (113A-113F) are each to be charged with a capacity of 10.4 Ah.

That is, the batteries (113A, 113B) having small actual capacities are overcharged (which is indicated by an area surrounded by a dotted line in FIG. 3(c)), whereas the batteries (113E, 113F) are in a state of being undercharged. In the overcharged batteries (113A, 113B), there is a possibility that destruction of a constituent material may occur, or an electrolysis reaction of electrolyte may occur on a surface of an active material, and rapid deterioration may occur.

Then, as illustrated in FIG. 3(d), for example, when the battery pack 11 is discharged to an 30% SOC the charge capacities of the batteries (113A-113F) are as follows: the battery (113A): 3.1 Ah; the battery (113B): 3.1 Ah; the battery (113C): 3.1 Ah; the battery (113D): 3.1 Ah; the battery (113E): 3.1 Ah; and the battery (113F): 3.2 Ah, which are approximately equal to each other. As a result, a large variation occurs in the values of “actual capacity-charge capacity” of the batteries (113A-113F). In this way, in the batteries (113A-113F), when variation occurs in the values of “actual capacity-charge capacity,” the batteries (113A, 113B) having small actual capacities are overcharged in next charging, which causes a rapid decrease in a battery capacity retention rate of the battery pack.

As described above, between the case where the battery pack is formed after the multiple batteries (13A-13F) are each charged to an 100% SOC (see FIG. 2) and the case where the battery pack is charged to an 100% SOC after being formed from the multiple batteries (113A-113F) (see FIG. 3), cycle lives and capacity retention rates of the produced battery packs are greatly different.

In the battery pack 11, even when a maximum capacity difference of the multiple batteries 13 forming the battery pack is 2.0% or more of a design capacity, the battery pack can be suitably used for the above-described reason. The term “maximum capacity difference” refers to a difference in actual capacity between a battery having a maximum actual capacity and a battery having a minimum actual capacity among the multiple batteries forming the battery pack. An upper limit of the maximum actual capacity difference is not particularly limited. However, the batteries 13 are produced to have the same capacity by design, and, typically, the maximum actual capacity difference is preferably 10% or less.

Further, according to the production method described above, when the battery pack 11 is produced, it is not necessary to consider variation in the actual capacities of the batteries 13. Therefore, it is also not necessary to select the batteries before assembling, which leads to reduction in time and cost.

For all of the batteries 13 of the battery pack 11, the state of charge (SOC) in a shipping state is 100%.

Here, the term “shipping state” refers to, in a device of the battery pack 11 including the batteries 13, either a state when the batteries 13 are packed for shipment or a state up to when discharging is started and the batteries 13 are used.

In the battery pack 11, the SOC of the batteries 13 may decrease due to self-discharge. A decrease in SOC after 30 days at 25° C. is preferably within 2%.

### <Charging and Discharging Device>

The charging and discharging device 12 has at least a function of charging and discharging the battery pack 11.

The charging and discharging device 12 preferably includes a control unit, and more preferably includes a control unit, a PV unit and a system cooperation unit.

The control unit has a blocking function of forcibly blocking a current when a preset abnormal voltage value, a preset abnormal current value, a preset abnormal temperature, or the like is reached.

Further, the control unit may have a monitoring function of monitoring a voltage value of the batteries 13 in the electricity storage device 10, and may have a discharge function of forcibly causing a battery to self-discharge so as to make the capacities uniform when there is variation in the capacities of the monitored batteries.

The discharge function may be a function of, for example, having a resistor and causing a battery to self-discharge.

Timing for the control unit to perform self-discharge is preferably during charging, and is more preferably at the time of full charge.

The PV unit has a function of charging power generated by a solar battery (PV), and a function of supplying power to a PV from the electricity storage device 10.

The system cooperation unit has a function of charging and discharging the electricity storage device 10 with respect to a commercial power supply.

The charging and discharging device 12 preferably includes a self-discharge load resistor that generates heat during self-discharge.

An installation site of the charging and discharging device 12 is not particularly limited. However, from a point of view that wiring is simplified and cost is reduced, the installation site is preferably within a casing of the electricity storage device 10, and, from a point of view that a low temperature is maintained and operation of the control unit is good, the installation site is more preferably on a lower side within the casing of the electricity storage device 10.

### <Method for Manufacturing Electricity Storage Device>

A method for manufacturing the electricity storage device 10 includes: a process in which the battery pack 11 is produced using the above-described production method; and a process in which, after the above process, the battery pack 11 is discharged to 30% SOC or more by the charging and discharging device 12.

In the electricity storage device 10, the battery pack 11 is suitably used when all of the batteries 13 are in 30% SOC or more, preferably in 30% SOC or more and 60% or less, and more preferably in 45% SOC or more and 60% or less. By setting the SOC to such a value, gas generation in the batteries 13 is suppressed.

### EXAMPLES

In the following, the present invention is more specifically described based on Examples. However, the present invention is not limited by these Examples.

### Example 1

First, a positive electrode active material containing Li_{1.1}Al_{0.1}Mn_{1.8}O₄ (hereinafter, referred to as LAMO) and lithium cobalt oxide (LCO) at a weight ratio of 22:1, acetylene black as a conductive additive, and PVdF as a binder were mixed such that their solid content concentrations were respectively 100 parts by weight, 5 parts by weight, and 5 parts by weight, and a positive electrode slurry was obtained.

In this case, a binder adjusted to a 5 wt % N-methyl-2-pyrrolidone (NMP) solution was used. Further, a number average particle diameter of LCO was 20 μm or less.

Thereafter, the positive electrode slurry was coated on one side of an aluminum foil having a thickness of 15 μm, and then was dried in an oven at 120° C.

Thereafter, the back side of the aluminum foil was also similarly coated and dried, and was further vacuum dried at 170° C.

Then, the aluminum foil was punched into 10 cm×10 cm. Through the above processes, a positive electrode was obtained.

In this case, the positive electrode had a capacity per one sheet of about 340 mAh.

Next, Li₄Ti₅O₁₂ as a negative electrode active material, acetylene black as a conductive additive, and PVdF as a binder were mixed such that their solid content concentrations were respectively 100 parts by weight, 5 parts by weight, and 5 parts by weight, and a negative electrode slurry was prepared.

A binder adjusted to a 5 wt % NMP solution was used.

Thereafter, the negative electrode slurry was coated on one side of an aluminum foil having a thickness of 15 μm, and then was dried in an oven at 120° C.

Thereafter, the back side of the aluminum foil was also similarly coated and dried, and was further vacuum dried at 170° C.

Then, the aluminum foil was punched into 10.5 cm×10.5 cm. Through the above processes, a negative electrode was obtained.

In this case, the negative electrode had a capacity per one sheet of about 397 mAh.

Next, 30 sheets of the positive electrode and 31 sheets of the negative electrode 31, and a separator formed of a cellulose-based nonwoven fabric having a width of 11 cm folded into zigzag folds, were laminated in the order of negative electrode/separator/positive electrode/separator/negative electrode/ . . . /negative electrode, and a laminated body was obtained.

Thereafter, terminals were respectively attached to the positive electrode and the negative electrode of the laminated body. Thereafter, the laminated body was sandwiched by two laminate films, and the aluminum laminate films were subjected to heat welding.

Then, 50 ml of a nonaqueous electrolyte solution was put in the laminated body, and the aluminum laminate films were sealed under a reduced pressure. In this case, as the nonaqueous electrolyte solution, a solution prepared by dissolving LiPF₆ at a concentration of 1 mol/L in a solvent containing ethylene carbonate (EC)/propylene carbonate (PC)/ethyl methyl carbonate (EMC) at 15/15/70 vol % was used.

Through the above processes, a battery having a rated voltage of 2.48 V and a design capacity of 10 Ah was obtained.

### (Production Examples of Battery Pack and Manufacturing Examples of Electricity Storage Device)

Next, 6 batteries were connected to a charging and discharging device (HJ1005SD8, manufactured by Hokuto Denko Corporation).

Thereafter, constant current and constant voltage charging at 1000 mA was performed in an atmosphere at 25° C. until a charge termination voltage of 2.7 V was reached.

Then, 6 batteries each having 100% SOC were obtained.

In this case, a maximum capacity difference of the battery pack was 0.8 Ah, and a ratio of the maximum capacity difference to a design capacity was 8%.

Thereafter, 6 batteries each having an 100% SOC were stacked parallel to a lamination direction of the laminated body and horizontally, and electrode terminals of the positive electrodes were connected on a main surface on one side.

Thereafter, terminals of negative electrodes on a main surface on the other side were connected, and a battery pack having 6 batteries connected in series was formed.

Then, a charging and discharging device was connected to the battery pack. Through the above processes, an electricity storage device in a shipping state was obtained.

### Example 2

A maximum capacity difference of a battery pack was set to 0.22 Ah, and a ratio of the maximum capacity difference to a design capacity was set to 2.2%. Other than that, Example 2 was the same as Example 1.

### Example 3

An electricity storage device in a shipping state was discharged until an SOC of a battery pack reached 30%. Other than that, Example 3 was the same as Example 1.

### Comparative Example 1

An SOC of each of batteries in a battery pack was set to 0%. Thereafter, an electricity storage device was formed using the batteries. Then, the electricity storage device was charged until the SOC of each of the batteries was 100% or more. Other than that, Comparative Example 1 was the same as Example 1.

### Comparative Example 2

An SOC of each of batteries in a battery pack was set to 0%. Thereafter, an electricity storage device was formed using the batteries. Thereafter, the electricity storage device was charged until the SOC of each of the batteries was 100% or more. Then, the electricity storage device in a shipping state was discharged until an SOC of the battery pack reached 30%. Other than that, Comparative Example 2 was the same as Example 1.

### (Cycle Life Test)

Charging and discharging with a constant current of 1000 mA was performed 1000 times in an atmosphere of 60° C. using the electricity storage device. In this case, a charge termination voltage was set to 2.7 V, and a discharge termination voltage was set to 2.0 V.

A ratio of 1000th discharge capacity of the c to 1st discharge capacity was taken as a capacity retention rate. For example, assuming 1st discharge capacity is 100, when 200th discharge capacity is 80, the capacity retention rate is 80%.

### (Measurement of Generated Gas Amount)

Thicknesses of all of the batteries of the electricity storage device were measured before and after the cycle life test, and a generated gas amount was calculated from change amounts of the thicknesses.

TABLE 1

| | | | | Ratio of | SOC | SOC of | | |
|---|---|---|---|---|---|---|---|---|
| | | | | maximum | of each | battery | | |
| | Maximum | Minimum | | capacity | battery | pack in | | |
| | battery | battery | Maximum | difference | in | electricity | Capacity | Generated |
| | actual | actual | capacity | to design | battery | storage | retention | gas |
| | capacity | capacity | difference | capacity | pack | device | rate | amount |
| | (Ah) | (Ah) | (Ah) | (%) | (%) | (%) | (%) | (ml) |
| Example 1 | 10.0 | 10.8 | 0.8 | 8.0 | 100 | 100 | 89.2 | 8.2 |
| Example 2 | 9.8 | 10.02 | 0.22 | 2.2 | 100 | 100 | 87.5 | 8.8 |
| Example 3 | 10.0 | 10.8 | 0.8 | 8.0 | 100 | 30 | 88.0 | 8.5 |
| Comparative | 10.0 | 10.8 | 0.8 | 8.0 | 0 | 100 | 65.0 | 20.0 |
| Example 1 | | | | | | | | |
| Comparative | 10.0 | 10.8 | 0.8 | 8.0 | 0 | 30 | 68.5 | 18.0 |
| Example 2 | | | | | | | | |

(Overall Evaluation of Table 1) Examples 1-3 were good with respect to the capacity retention rate and the generated gas amount. In comparison, Comparative Examples 1 and 2, which are outside the technical scope of the present invention, were poor with respect to the capacity retention rate and the generated gas amount as compared to Examples.

### DESCRIPTION OF REFERENCE NUMERALS

10: electricity storage device
11: battery pack
12: charging and discharging device
13 batteries

1. A method for producing a battery pack, comprising:
charging each of a plurality of batteries to 100% state of charge (SOC), and
connecting charged batteries such that at least some of the batteries are serially connected to each other, and that the battery pack is formed,
wherein each of the batteries has a positive electrode comprising a layered rock salt type compound and a negative electrode comprising a titanium compound.

2. The method of claim 1, wherein the positive electrode further comprises spinel type lithium manganate.

3. The method of claim 1, wherein the titanium compound comprises at least one selected from the group consisting of a titanic acid compound, a lithium titanate and a titanium dioxide.

4. The method of claim 1, wherein a maximum capacity difference of the batteries is 2% or more of a design capacity.

5. A method for manufacturing an electricity storage device, comprising:
producing a battery pack by the method of claim 1; and
discharging the battery pack to 30% SOC or more.

6. The method of claim 1, wherein positive electrode further comprises at least one of a metal oxide and a metal transition metal composite oxide.

7. The method of claim 1, wherein each of the batteries further includes a separator between the positive electrode and the negative electrode.

8. The method of claim 1, wherein each of the batteries further includes a nonaqueous electrolyte solution.

9. The method of claim 8, wherein the nonaqueous electrolyte solution comprises at least one lithium salt selected from the group consisting of LiPF₆, LiClO₄, LiBF₄, LiAsF₆, LiCF₃SO₃, LiBOB, Li[N(SO₂CF₃)₂], Li[N(SO₂C₂F₅)₂], Li[N(SO₂F)₂], and Li[N(CN)₂].

10. The method of claim 1, wherein each of the batteries includes a laminated body including the positive electrode, the negative electrode, and a separator between the positive electrode and the negative electrode, a nonaqueous electrolyte solution and terminals.

11. The method of claim 10, wherein the positive electrode, the negative electrode and the separator are alternately laminated or wound in the laminated body.

12. The method of claim 2, wherein the titanium compound comprises at least one selected from the group consisting of a titanic acid compound, a lithium titanate and a titanium dioxide.

13. The method of claim 2, wherein a maximum capacity difference of the batteries is 2% or more of a design capacity.

14. The method of claim 3, wherein a maximum capacity difference of the batteries is 2% or more of a design capacity.

15. The method of claim 1, wherein at least some of the batteries in the battery pack are connected in parallel.

16. The method of claim 5, wherein in the discharging, the battery pack is discharged to 30% SOC or more and 60% SOC or less.

17. The method of claim 5, wherein in the discharging, the battery pack is discharged to 45% SOC or more and 60% SOC or less.

18. A method for manufacturing an electricity storage device, comprising:
producing a battery pack by the method of claim 2; and
discharging the battery pack to 30% SOC or more.

19. A method for manufacturing an electricity storage device, comprising:
producing a battery pack by the method of claim 3; and
discharging the battery pack to 30% SOC or more.

20. A method for manufacturing an electricity storage device, comprising:
producing a battery pack by the method of claim 4; and
discharging the battery pack to 30% SOC or more.
